(19) United States
(12) Patent Application Publication
(10) Pub. No.: US 2006/0281852 A1
(43) Pub. Date: Dec. 14, 2006

(54) Resin-base interior finish material

(75) Inventor: Toshiaki Inada, Chiba (JP)

Correspondence Address: NIXON PEABODY, LLP, 401 9TH STREET, NW, SUITE 900, WASHINGTON, DC, 20004-2128, US

(73) Assignee: NITTO BOSEKI., LTD., Fukushima-shi, Fukushima (JP)

(21) Appl. No.: 10/553,072

(22) PCT Filed: May 16, 2003
(86) PCT No.: PCT/JP03/06144

§ 371 Date: Oct. 12, 2005

(51) Int. Cl. C08L 31/04; C08L 37/00

(52) U.S. Cl. 524/524; 524/517

(57) ABSTRACT

A resinous interior material is provided which comprises 10 to 45 parts by mass of an ethylene/vinyl acetate copolymer, 10 to 90 parts by mass of a polyolefin resin, 10 to 90 parts by mass of either a block copolymer of styrene and one or more aliphatic unsaturated hydrocarbon compounds or a product of hydrogenation of the copolymer (styrene/(poly)olefin block copolymer), and 100 to 700 parts by mass of an inorganic filler. This resinous interior material contains neither halogens nor plasticizers such as phthalic esters, can be used as a substitute for interior materials made of PVC resins, and has excellent adhesion to adhesives and waxes heretofore in use for interior materials. In addition, this resinous interior material is markedly superior in processability, applicability, and durability to other interior materials made of non-halogen resins. Especially when the ethylene/vinyl acetate copolymer has a melt flow rate higher by at least 20 g/10 min than the MFR's of the other resins and the styrene/(poly)olefin block copolymer has a glass transition temperature (T_{g} or tan 6 absorption) around ordinary temperature, then the interior material is satisfactory in conformability to substrates, marring resistance, and abrasion resistance.

### TECHNICAL FIELD

The present invention relates to a resinous interior material. Particularly, the invention relates to a resinous interior material which contains neither halogens nor plasticizers such as phthalic esters and has sufficient performances which make the interior material usable as a substitute for existing interior materials made of PVC resins (vinyl chloride resins). More particular, the invention relates to a resinous interior material (e.g., a flooring material or skirting board) remarkably improved in processability, durability, and conformability to substrates in application as compared with non-halogen-resin interior materials usable as substitutes for existing PVC-resin interior materials.

### BACKGROUND ART

PVC resins have come to be extensively used because these resins are easy to mold, give an attractive appearance, and are excellent in applicability, abrasion resistance, etc. when used as flooring materials.

However, under the circumstances in which environmental issues have been raised, there are fears about the generation of toxic gases such as hydrogen chloride gas and dioxins during combustion and about influences of pollutants for indoor environments and phthalic ester plasticizers suspected as environmental hormones on the human body. Polyolefin-based flooring materials containing no halogens and no plasticizers have been proposed. For example, in JP-A-11-48416 is described a continuous flooring material comprising a polyolefin, an ethylene/vinyl acetate copolymer (EVA), and a modified olefin resin or olefin/acrylic copolymer.

However, since polyolefin resins such as polyethylene and polypropylene have no polarity, sufficient adhesive force is not obtained with existing adhesives for flooring materials even when a general resin having polar groups, such as an EVA or EEA (ethylene/ethyl acrylate copolymer), is used therewith. For the same reason, sufficient adhesion has not been obtained with existing waxes for flooring materials. In addition, because of the high crystallinity of those resins, the flooring materials obtained have poor applicability.

An interior material which may eliminate those problems is described in WO 00/23518. This interior material employs as a base resin a blend of an ethylene/vinyl acetate copolymer having a vinyl acetate content of 50% or higher and a high melt flow rate (hereinafter referred to as MFR) with a polyolefin resin having a low MFR in a specific proportion. In that document, there is a statement to the following effect. The ethylene/vinyl acetate copolymer has an exceedingly high polar-group content, i.e., a vinyl acetate content of 50% or higher, and this ethylene/vinyl acetate copolymer has an MFR which is higher by at least 20 g/10 min than the MFR's of the other resin ingredients. Because of this, the copolymer, after having been mixed, is not in a completely compatibilized state but in the state of being dispersed as fine particles throughout the system. The copolymer is hence scattered throughout the system while retaining the high polar-group concentration. Consequently, the interior material has far higher adhesion to various adhesives and waxes than the polyolefin-based interior materials heretofore in use. In addition, since the ethylene/vinyl acetate copolymer is noncrystalline, it is highly effective in imparting flexibility.

On the other hand, JP-A-2002-284936 and JP-A-2002-294996 describe flooring tiles excellent in marring resistance, deformability (stress relaxation under tile-elongating pressure from below) , adhesion to substrates, and applicability (conformability to substrates). These flooring tiles are molded from a material obtained by incorporating an ethylene/styrene random copolymer into a resin composition for flooring tiles which comprises an ethylene copolymer, e.g., an ethylene/vinyl acetate copolymer or ethylene/acrylic acid copolymer, and a polyolefin resin.

However, the ethylene/styrene random copolymer itself used in each of the resinous interior materials has high temperature sensitivity and hence poor processability. It is therefore necessary to compensate for this drawback by adding other resins. As a result, the final product cannot fully take advantage of the properties of the ethylene/styrene random copolymer. There currently is a desire for a resinous interior material having even better processability, durability, and conformability to substrates.

Consequently, an object of the invention is to provide a resinous interior material markedly improved in processability, durability, and conformability in application by using non-PVC resins including an olefin resin.

### DISCLOSURE OF THE INVENTION

That subject for the invention was found to be accomplished with a resinous interior material comprising 10-45 parts by mass of an ethylene/vinyl acetate copolymer, 10-90 parts by mass of a polyolefin resin, 10-90 parts by mass of either a block copolymer of styrene and one or more aliphatic unsaturated hydrocarbon compounds or a product of hydrogenation of the copolymer (hereinafter referred to as styrene/(poly)olefin block copolymer), and 100-700 parts by mass of an inorganic filler.

By thus adding a styrene/ (poly) olefin block copolymer to a resinous interior material containing an ethylene/vinyl acetate copolymer and a polyolefin resin in a specific proportion, processability, durability, and conformability in application are markedly improved.

The styrene/(poly)olefin block copolymer in the invention comprises a polystyrene block and a (poly)olefin block. The polystyrene block serves to improve the strength of the whole because the cohesive force among the styrene units is high, while the (poly)olefin block serves to impart flexibility. Furthermore, styrene blocks located at molecular chain ends attract each other to thereby produce an effect similar to that of crosslinks in rubbers. The copolymer can hence have rubber elasticity although it is a thermoplastic resin. In addition, the copolymer shows stable properties during processing, such as, e.g., melt tension, and has excellent processability. Consequently, a resinous interior material which is excellent in durability, e.g., unsusceptibility to marring, abrasion resistance, and unsusceptibility to cracking, is flexible, and has excellent conformability and excellent processability is obtained as a final product.

The styrene/(poly)olefin copolymer in the invention preferably has a glass transition temperature (T_{g} or tan δ absorption) in an ordinary-temperature range, preferably from −20° C. to +50° C. When the copolymer has a glass transition temperature in an ordinary-temperature range, the interior material has improved stress-relaxing properties in the temperature range in which the interior material is to be used. In the case where this interior material is bonded to, e.g., a substrate, it shows satisfactory conformability to the substrate. For the same reason, external stresses are relaxed. The interior material hence is excellent in marring resistance and abrasion resistance and has improved durability.

The vinyl acetate content (hereinafter referred to also as polar-group content) of the ethylene/vinyl acetate copolymer is preferably 50% or higher, more preferably 60-80%. When the polar-group content thereof is 50% or higher, the interior material has improved adhesion to adhesives and waxes. It is preferred that the MFR of the ethylene/vinyl acetate copolymer be higher by at least 20 g/10 min, especially at least 30 g/10 min, than the MFR's of the other resin ingredients. When the difference in MFR is 20 g/10 min or larger, the interior material is apt to have a structure in which the ethylene/vinyl acetate copolymer having a high polar-group content is present as finely dispersed particles. Satisfactory adhesiveness is hence obtained.

As long as the MFR of the ethylene/vinyl acetate copolymer having a high polar-group content is higher by at least 20 g/10 min than the MFR's of the other resins, the effect is obtained. However, it is preferred that the MFR of the ethylene/vinyl acetate copolymer be in the range of 40-100 g/10 min, especially 40-80 g/10 min, and the MFR's of the other resins be in the range of 1-10 g/10 min.

Incidentally, the term MFR as used in the invention has the same meaning as the melt flow index shown in JIS K 6900 (Plastic terms). MFR can be measured in accordance with JIS K 7210.

The polyolefin resin in the invention means a polymer of one or more olefins (aliphatic unsaturated hydrocarbon compounds having one double bond in the molecule) . The polyolefin resin is not particularly limited, and examples thereof include polyethylene, polypropylene, and ethylene/ethyl acrylate copolymers. This polyolefin resin is neither an ethylene/vinyl acetate copolymer nor a styrene/(poly)olefin block copolymer.

The styrene/(poly)olefin block copolymer in the invention means either a block copolymer of styrene and one or more aliphatic unsaturated hydrocarbon compounds or a product of hydrogenation of the copolymer. Hydrogenation improves heat resistance and weatherability and imparts satisfactory compatibility with other polyolefin resins. The aliphatic unsaturated hydrocarbon compounds are aliphatic hydrocarbon compounds having at least one double bond. Examples thereof include aliphatic hydrocarbon compounds having one double bond in the molecule (olefins), such as ethylene, n-propylene, isopropylene, 1-butene, isobutylene, 1-hexene, 1-pentene, and 4-methyl-1-pentene, and aliphatic hydrocarbon compounds having two or more double bonds in the molecule (polyenes or polyolefins), such as butadiene and isoprene. Especially preferred are aliphatic unsaturated hydrocarbon compounds having 3 or more carbon atoms.

The styrene/(poly)olefin block copolymer in the invention may be a commercial one. Examples thereof include Hybrar 5127 (manufactured by Kuraray Co., Ltd.) and Hybrar 7125 (manufactured by Kuraray Co., Ltd.).

The glass transition temperature of the styrene/(poly)olefin block copolymer desirably is around ordinary temperature. The temperature is not particularly limited in obtaining an interior material which is flexible even at low temperatures. However, the glass transition temperature thereof is preferably from −20 to +50° C. When the glass transition temperature of the copolymer is −20° C. or higher, satisfactory stress-relaxing properties are obtained and the desired durability and, in particular, conformability in application are satisfactorily exhibited. Glass transition temperatures thereof not higher than 50° C. are preferred because the resin does not become vitreous and hard or brittle at the actual use temperature for the interior material and satisfactory conformability in application is maintained. The styrene/(poly)olefin block copolymer to be used preferably has a glass transition temperature around ordinary temperature because use of this copolymer brings about those performances. However, a styrene/(poly)olefin block copolymer having a glass transition temperature which is not around ordinary temperature may be added, according to uses, to the styrene/(poly)olefin block copolymer having a glass transition temperature around ordinary temperature to thereby regulate the hardness or other properties of the interior material.

The inorganic filler in the invention is not particularly limited, and any of the inorganic fillers heretofore in use in interior materials, such as calcium carbonate, magnesium carbonate, talc, silica, clay, aluminum hydroxide, magnesium hydroxide, glass fibers, and mineral fibers, can be used.

The amount of the inorganic filler to be incorporated is 100-700 parts by mass. The amount thereof can be suitably determined in this range according to the intended use and kind of the interior material. When the amount thereof is within this range, advantages of the incorporation of the inorganic filler (rigidity, processability, cost, etc.) can be sufficiently obtained without impairing the features of the invention described above.

Various additives known as additives for resinous interior materials, such as a pigment, crosslinking agent, antioxidant, lubricant, processing aid, and light stabilizer, can be optionally incorporated into the resinous interior material of the invention.

The resinous interior material of the invention can be extensively used as interior materials such as flooring materials, skirting boards, wainscot sheets, and wall papers. The interior material is especially useful as a flooring material and a skirting board because it is excellent in durability such as abrasion resistance and marring resistance and in conformability to substrates and because an inexpensive product can be produced by adding a large amount of a filler.

### BEST MODE FOR CARRYING OUT THE INVENTION

(1) A flooring material characterized by being produced by compounding 10-45 parts by mass of an ethylene/vinyl acetate copolymer having a vinyl acetate concentration of 50% or higher and an MFR of 40-100 g/10 min with 20-70 parts by mass of a polyolefin resin having an MFR of 1-20 g/10 min, 20-70 parts by mass of a styrene/(poly)olefin block copolymer having a glass transition temperature around ordinary temperature and an MFR of 1-20 g/10 min, and 400-700 parts by mass of an inorganic filler and molding the resultant composition into a single-layer structure.

(2) A skirting board characterized by being produced through compounding 10-45 parts by mass of an ethylene/vinyl acetate copolymer having a vinyl acetate concentration of 50% or higher and an MFR of 40-100 g/10 min with 20-70 parts by mass of a polyolefin resin having an MFR of 1-20 g/10 min, 20-70 parts by mass of a styrene/(poly)olefin block copolymer having a glass transition temperature around ordinary temperature and an MFR of 1-20 g/10 min, and 150-400 parts by mass of an inorganic filler.

First, the case in which the resinous interior material of the invention is used as a flooring material is explained in detail.

The flooring material which contains, as base resins, 10-45 parts by mass of an ethylene/vinyl acetate copolymer having a vinyl acetate concentration of 50% or higher and an MFR of 40-100 g/10 min, 20-70 parts by mass, preferably 30-60 parts by mass, of a polyolefin resin having an MFR of 1-20 g/10 min, and 20-70 parts by mass, preferably 30-60 parts by mass, of a styrene/(poly)olefin block copolymer having a glass transition temperature around ordinary temperature and an MFR of 1-20 g/10 min, as shown under (1) above, not only shows excellent adhesion to existing adhesives for flooring materials and waxes for flooring materials as compared with non-halogen flooring materials having other compositions but also is markedly superior to such flooring materials in processability, durability, and conformability in application, as apparent from the experimental data which will be shown later.

Since the ethylene/vinyl acetate copolymer having a vinyl acetate content of 50% or higher and an MFR of 40-100 g/10 min has a vinyl acetate content of 50% or higher, a sufficient polar-group concentration is maintained and the effect of improving adhesion to adhesives and waxes is obtained. When the copolymer has an MFR of 40 g/10 min or higher, a sufficient difference in MFR is obtained between this copolymer and other resins and the structure including fine particles is apt to be formed. When the copolymer has an MFR of 100 g/10 min or lower, the strength of the base resins blended is kept sufficient and performances required of flooring materials, such as abrasion resistance, can be satisfactorily maintained.

When the amount of the ethylene/vinyl acetate copolymer having a vinyl acetate content of 50% or higher and an MFR of 40-100 g/10 min is 10 parts by mass or larger, the high-concentration polar groups dispersed throughout the system are kept sufficient. When the amount thereof is 45 parts by mass or smaller, the strength of the base resins is sufficiently obtained and performances required of flooring materials, such as abrasion resistance, can be satisfactorily maintained.

When the MFR's of the other resins are 20 g/10 min or lower, a sufficient difference in MFR between each of these resins and the ethylene/vinyl acetate copolymer can be maintained and the structure including finely dispersed particles is apt to be formed. It is therefore preferred that the other resins to be used should have an MFR of 20 g/10 min or lower, desirably 10 g/10 min or lower.

In the flooring material, it is especially preferred to use a polyethylene as the polyolefin resin. Although the polyethylene is not particularly limited, a low-density polyethylene is preferred when moldability with, e.g., a calendar is taken into account. It is more preferred to use linear low-density polyethylene because it brings about satisfactory processability.

It is especially preferred that the styrene/(poly)olefin block copolymer to be used in the flooring material be one having a glass transition temperature of from −10 to 40° C. This is because when a styrene/(poly)olefin block copolymer having a glass transition temperature of from −10 to 40° C. is used, the flooring material has satisfactory stress-relaxing properties and is satisfactory in conformability to flooring bases, recovery from stresses caused by a point load, abrasion resistance, and marring resistance.

Furthermore, since the styrene/(poly)olefin block copolymer does not have a distinct melting point unlike crystalline resins and shows a constant viscosity change with temperature, molding can be conducted in a wide temperature range. In addition, since the styrene/(poly)olefin block copolymer has moderate flowability and melt tension in a high-temperature range, a satisfactory roll bank state is obtained and processability is markedly improved when the flooring material is produced by, e.g., calendaring.

The amount of the inorganic filler to be incorporated in the flooring material is preferably 400-700 parts by mass, more preferably 450-650 parts by mass. When the inorganic filler is contained in an amount of 400 parts by mass or larger, an appropriate resin content can be provided and the flooring material of a single-layer structure obtained can have satisfactory rigidity and be free from troubles concerning material properties, e.g., a residual depression can be diminished. With respect to cost also, this flooring material is not so expensive as compared with PVC flooring materials. In addition, in the flooring material in which the amount of the inorganic filler is 400 parts by.mass or larger, the area of that surface part of the flooring material which is occupied by the inorganic filler is larger than in flooring materials having smaller inorganic-filler amounts. This flooring material hence has improved adhesion to adhesives and waxes and further has improved flame retardancy. On the other hand, inorganic-filler amounts not larger than 700 parts by mass are preferred because satisfactory processability is obtained.

As the inorganic filler can be used any of various fillers which have been known as fillers for flooring materials, such as calcium carbonate, magnesium carbonate, talc, silica, clay, glass fibers, and mineral fibers. However, a calcium carbonate powder having an average particle diameter of 500 pum or smaller is especially preferred. Furthermore, when a calcium carbonate powder is used as a mixture with an aluminum hydroxide powder or magnesium hydroxide powder, a flooring material having a high degree of flame retardancy is obtained.

A great feature of the flooring material of the invention resides in that it can be produced through molding into a single-layer structure. Namely, the material is excellent in suitability for waxing, abrasion resistance, and marring resistance, which are required of the front side, and in adhesiveness, which is required of the back side. Consequently, the flooring material molded into a single-layer structure has sufficient features of constituent materials, without the necessity of having a multilayer structure. In addition, since processability has been remarkably improved, the flooring material has highly excellent productivity and can be produced at especially low cost. Furthermore, since this flooring material including its front side and back side has been integrally molded, it is free from the trouble of color/pattern disappearance by wearing, such as the trouble in multilayered products that a surface layer is worn away and an interlayer or back layer is exposed to impair the appearance of the flooring material. The flooring material of the invention hence has an exceedingly long life.

By further incorporating a copolymer of methyl methacrylate (hereinafter referred to as MMA) and an acrylic ester in an amount of 10-50 parts by mass, the marring resistance of the flooring material is further improved markedly. The polymerof MMA alone,i.e., methyl methacrylate, is a rigid resin, and use of poly(methyl methacrylate) gives a flooring material which is rigid and brittle and has poor applicability. However, by using a resin obtained by copolymerizing MMA with an acrylic ester, some degree of flexibility is obtained and a flooring material having satisfactory applicability is obtained. Processability in, e.g., kneading is also improved. These effects are thought to be attributable to the fact that the copolymerization of MMA with an acrylic ester yields a copolymer having a lower melting point than poly(methyl methacrylate).

In addition, since the MMA/acrylic ester copolymer has polar groups in the molecular structure, incorporation of this copolymer into the flooring material of the invention enables the adhesion of adhesives or waxes to be maintained or improved.

Examples of the acrylic ester include methyl acrylate, ethyl acrylate, and butyl acrylate. In case where the amount of the MMA/acrylic ester copolymer incorporated is smaller than 10 parts by mass, the effects described above are not produced. In case where the copolymer is incorporated in an amount larger than 50 parts by mass, the resultant product is considerably brittle and tends to have impaired applicability. Consequently, the amount of the copolymer to be incorporated is optimally 10-50 parts by mass, more preferably 20-40 parts by mass.

Furthermore, by incorporating an ethylene/acrylic ester/maleic anhydride terpolymer into the flooring material of the invention in an amount of 10-30 parts by mass, especially the abrasion resistance of the flooring material is further improved markedly. In addition, the molten sheet during production comes to have nerve, resulting in improved processability. The reasons for these are thought to be, for example, as follows: (1) the ethylene/acrylic ester/maleic anhydride terpolymer has satisfactory compatibility with the other resin ingredients; and (2) especially the maleic anhydride in the ethylene/acrylic ester/maleic anhydride terpolymer exceedingly satisfactorily adheres to the inorganic filler and, hence, the resin ingredients tenaciously adhere to the inorganic filler.

In case where the amount of the ethylene/acrylic ester/maleic anhydride terpolymer incorporated is smaller than 10 parts by mass, the effects described above are not produced. Even when the terpolymer is incorporated in an amount larger than 30 parts by mass, the abrasion resistance attained when the terpolymer amount is within that range is not improved any more. Consequently, the amount of the terpolymer to be incorporated is optimally 10-30 parts by mass, more preferably 15-25 parts by mass.

Moreover, by further incorporating a tackifier such as, e.g., a petroleum resin or a rosin into the flooring material of the invention in an amount of 10-30 parts by mass, more preferably 15-25 parts by mass, adhesion to adhesives and waxes is further improved.

The following should be noted. Only when a tackifier is incorporated in an amount within that range into the flooring material of the invention which has sufficiently enhanced adhesion to adhesives and waxes for the reasons shown above, then the flooring material has further enhanced performances. Even if a tackifier alone is incorporated into flooring materials-heretofore in use, sufficient adhesion to adhesives or waxes cannot be obtained.

Various additives known as additives for resinous flooring materials, such as a pigment, crosslinking agent, antioxidant, lubricant, processing aid, and light stabilizer, can be optionally incorporated into the flooring material of the invention.

The flooringmaterial of the invention has a single-layer structure having an even composition. It especially preferably is one molded into a tile form. For example, the flooring material can be in the form of a square flooring tile in which each side has a length of about 30-60 cm. This flooring tile may be one obtained by calendaring a monochromatic composition, or may be one having a splashed pattern obtained from the composition to which a patterning material has been added. Alternatively, the flooring tile may be one obtained by molding chips of many colors into a multilayer structure with a calendar or press.

The thickness of the flooring material of a single-layer structure is not particularly limited. However, it is preferably about 2-4 mm.

The flooring material of a single-layer structure described above can be produced according to the example shown below.

First, 10-45 parts by mass of an ethylene/vinyl acetate copolymer having a vinyl acetate content of 50% or higher and an MFR of 40-100 g/10 min is mixed with 20-60 parts by mass of polyethylene having an MFR of 1-10 g/10 min, 20-60 parts by mass of a styrene/polyolefin copolymer having a glass transition temperature around ordinary temperature and an MFR of 1-10 g/10 min, and 400-700 parts by mass of an inorganic filler and optionally with 10-50 parts by mass of an MMA/acrylic ester copolymer, 10-30 parts by mass of an ethylene/acrylic ester/maleic anhydride terpolymer, 1-30 parts by mass of a tackifier such as a petroleum resin or rosin, and a small amount of additives by means of a ribbon blender or the like.

This mixture is melt-kneaded with a Banbury mixer or pressure kneader, sheeted in a given thickness with mixing rolls and calendar rolls, subsequently cooled, and then cut into a given size by punching to obtain the target flooring material.

Adhesives and waxes which are presently in general use for flooring materials tenaciously adhere to the flooring material thus obtained, as will be shown by the data given later. In addition, this flooring material is exceedingly satisfactory in performances such as abrasion resistance, marring resistance, and conformability to substrates.

Next, the case in which the resinous interior material of the invention is used as a skirting board is explained in detail.

The skirting board which contains, as base resins, 10-45 parts by mass of an ethylene/vinyl acetate copolymer having a vinyl acetate concentration of 50% or higher and an MFR of 40-100 g/10 min, 20-70 parts by mass of a polyolefin resin having an MFR of 1-20 g/10 min, and 20-70 parts by mass of a styrene/(poly)olefin block copolymer having a glass transition temperature around ordinary temperature and an MFR of 1-20 g/10 min, as shown under (2) above, not only shows excellent adhesion to existing adhesives for skirting boards as compared with skirting boards having other compositions, in particular, non-halogen skirting boards having other compositions, but also is markedly superior to such skirting boards inprocessability, marring resistance, unsusceptibility to blushing in bending, and conformability in application, as apparent from the experimental data which will be shown later.

Since the ethylene/vinyl acetate copolymer having a vinyl acetate content of 50% or higher and an MFR of 40-100 g/10 min has a vinyl acetate content of 50% or higher, a sufficient polar-group concentration is maintained and the effect of improving adhesion to adhesives is obtained. When the copolymer has an MFR of 40 g/10 min or higher, a sufficient difference in MFR is obtained between this copolymer and other resins and the structure including fine particles is apt to be formed. When the copolymer has an MFR of 100 g/10 min or lower, a molding which has satisfactory performances and does not give a tacky feeling is obtained. That range of MFR is therefore preferred.

When the amount of the ethylene/vinyl acetate copolymer having a vinyl acetate content of 50% or higher and an MFR of 40-100 g/10 min is 10 parts by mass or larger, the high-concentration polar groups dispersed throughout the system are kept sufficient. When the amount thereof is 45 parts by mass or smaller, that part of the resin ingredients which is less crystalline is present in an appropriate amount and a molding which has satisfactory performances and does not give a tacky feeling is obtained. That range of the amount of the copolymer is therefore preferred.

When the MFR's of the other resins are 20 g/10 min or lower, a sufficient difference in MFR between each of these resins and the ethylene/vinyl acetate copolymer is obtained and the structure including finely dispersed particles is apt to be formed. It is therefore preferred that the other resins to be used should have an MFR of 20 g/10 min or lower, desirably 10 g/10 min or lower.

It is especially preferred that the styrene/(poly)olefin block copolymer to be used in the skirting board be one having a glass transition temperature of from −10 to40° C. This is because when a styrene/ (poly) olefin block copolymer having a glass transition temperature of from −10 to 40° C. is used, the skirting board has satisfactory stress-relaxing properties and is satisfactory in conformability to substrates, conformability in bending, unsusceptibility to blushing in bending, and marring resistance.

Furthermore, since the styrene/(poly)olefin block copolymer does not have a distinct melting point unlike crystalline resins and shows a constant viscosity change with temperature, molding can be conducted in a wide temperature range. In addition, since the copolymer has moderate flowability and melt tension in a high-temperature range, troubles in production by, e.g., extrusion molding, such as melting down, are inhibited. The composition can hence be easily handled during processing.

The amount of the inorganic filler to be incorporated in the skirting board is preferably 150-400 parts by mass, more preferably 200-300 parts by mass. When the inorganic filler is contained in an amount of 150 parts by mass or larger, satisfactory flame retardancy is obtained. When the inorganic filler is contained in an amount of 400parts by mass or smaller, a skirting board having moderate strength and satisfactory unsusceptibility to blushing in bending is obtained. As the inorganic filler can be used any of inorganic fillers which have been used as fillers for interior materials, such as calcium carbonate, magnesium carbonate, talc, silica, clay, glass fibers, and mineral fibers. However, a calcium carbonate powder having an average particle diameter of 500 μm or smaller is especially preferred. Furthermore, when a calcium carbonate powder is used as a mixture with an aluminum hydroxide powder or magnesium hydroxide powder, a skirting board having a high degree of flame retardancy is obtained.

By further incorporating an ethylene/maleic anhydride copolymer or an ethylene/methacrylic acid copolymer in an amount of 1-30 parts by mass, the skirting board of the invention is markedly improved especially in unsusceptibility to blushing in bending. In addition, the molten sheet during production comes to have nerve, resulting in improved productivity. The reasons for these are thought to be, for example, as follows: (1) the ethylene/maleic anhydride copolymer or ethylene/methacrylic acid copolymer has satisfactory compatibility with the other resin ingredients; and (2) the maleic anhydride in the ethylene/maleic anhydride copolymer or the methacrylic acid in the ethylene/methacrylic acid copolymer exceedingly satisfactorily adheres to the inorganic filler and, hence, the resin ingredients tenaciously adhere to the inorganic filler.

When the amount of the ethylene/maleic anhydride copolymer or ethylene/methacrylic acid copolymer incorporated is within the range of 1-30 parts by mass, the effect of improving those properties is effectively obtained. The amount of the copolymer to be incorporated is especially preferably 10-30 parts by mass. More preferably, the amount thereof is 10-20 parts by mass.

Furthermore, by incorporating a tackifier such as, e.g., a petroleum resin or a rosin in an amount of 1-30 parts by mass, adhesion to adhesives is further improved. when the amount of the tackifier incorporated is 30 parts by mass or smaller, a stable hue is obtained and satisfactory unsusceptibility to blushing in bending is maintained. When the amount thereof is 1 part by mass or larger, the effect of improving adhesiveness is satisfactorily produced. Consequently, that amount of the tackifier to be incorporated is optimal. More preferably, the amount thereof is 10-20 parts by mass.

The following should be noted. Only when a tackifier is incorporated in an amount within that range into the specific resinous skirting board of the invention which has sufficiently enhanced adhesion to adhesives for the reasons shown above, then the skirting board has further enhanced performances as shown also in WO 00/23518. Even if-a tackifier alone is incorporated into non-halogen-resin skirting boards heretofore in use, sufficient adhesion to adhesives cannot be obtained.

Various additives known as additives for resinous skirting boards, such as a pigment, crosslinking agent, antioxidant, lubricant, processing aid, and light stabilizer, can be optionally incorporated into the skirting board of the invention.

The skirting board of the invention can have a surface layer formed by superposing an ionomer resin. This surface layer brings about exceedingly high marring resistance and more effectively prevents the blushing caused by bending. The reasons for this are, for example, that ionomer resins are exceedingly tough, have high surface hardness, and have moderate elasticity and flexibility.

Ionomer resins further have excellent heat sealability and hence have satisfactory processability not only in coextrusion but in film laminating.

Furthermore, the skirting board having a surface layer formed by superposing a nylon resin also has exceedingly high marring resistance and is more effectively prevented from blushing upon bending. The reasons for this are, for example, that nylon resins are exceedingly tough, have high surface hardness, and have moderate elasticity and flexibility.

In the case where a nylon resin is bonded by coextrusion, especially no problem arises. However, in the case where the resin is to be bonded as a film, use may be made of a film having a multilayer structure produced by the coextrusion of a nylon resin and a polyolefin resin for the purpose of improving heat sealability. In this case, it is a matter of course that the surface layer of the film is the nylon resin and the adhesive layer on the back side is the polyolefin resin.

This surface layer made of an ionomer resin or nylon resin may be transparent or may have been colored or matted by adding any of various fillers; pigments, etc. It is also possible to impart an attractive appearance by, e.g., interposing a layer formed by printing between the surface layer and the underlying layer.

The skirting board of the invention has been molded so as to have a single-layer or multilayer structure, and the thickness thereof is not particularly limited. However, the thickness thereof is preferably 1-3 mm.

The skirting board of the invention can be produced according to the example shown below.

First, 10-45 parts by mass of an ethylene/vinyl acetate copolymer having a vinyl acetate content of 50% or higher and an MFR of 40-100 g/10 min is kneaded together with 20-60 parts by mass of a polyolefin resin having an MFR of 1-20 g/10 min, 20-60 parts by mass of a styrene/ (poly)olefin block copolymer having a glass transition temperature around room temperature and an MFR of 1-20 g/10 min, and 50-300 parts by mass of an inorganic filler and optionally with 1-30 parts by mass of an ethylene/maleic anhydride copolymer or ethylene/methacrylic acid copolymer, 1-30 parts by mass of a tackifier such as a petroleum resin or rosin, and a small amount of additives. The resultant composition is molded into a sheet with an extruder equipped with a die having the corresponding orifice shape. Thus, the target skirting board is obtained.

In the case where an ionomer resin or nylon resin is superposed as a surface layer, another extruder is used to mold a surface layer sheet and this sheet is immediately laminated to the sheet described above. Thus, the target skirting board can be obtained.

The skirting board thus obtained can be tenaciously bonded with adhesives presently in general use for skirting boards, as will be shown by the data given later. In addition, this skirting board is exceedingly satisfactory in conformability to substrates and unsusceptibility to blushing in bending, these properties being far better than those of the skirting boards made of other non-halogen resins. In particular, the resinous skirting board having a surface layer formed by superposing an ionomer resin or nylon resin is highly excellent in marring resistance. and unsusceptibility to blushing in bending.

### EXAMPLES

The resinous interior material of the invention will be illustrated below by means of Examples, but the invention should not be construed as being limited by these Examples.

### EXAMPLE 1

Thirty parts by mass of an ethylene/vinyl acetate copolymer having a vinyl acetate content of 70% by mass (Soalex R-DH, manufactured by The Nippon Synthetic Chemical Industry Co., Ltd.; MFR, 50 g/10 min; hereinafter referred to as “EVAL”) was evenly kneaded together with 35 parts by mass of low-density polyethylene (Sumikathene EFV402, manufactured by Sumitomo Chemical Co., Ltd.; MFR, 4 g/10 min), 35 parts by mass of a polystyrene/1,2-polyisoprene block copolymer (Hybrar 5127, manufactured by Kuraray Co., Ltd.; MFR, 5 g/10 min; glass transition temperature, 8° C.; hereinafter referred to as “styrene/(poly)olefin copolymer 1 ”), and 500 parts by mass of a calcium carbonate powder having an average particle diameter of 100 μm by means of a Banbury mixer. The resultant composition was molded into a sheet having a thickness of 2 mm with mixing rolls and calendar rolls. This sheet was cooled and then cut into a given size by punching to produce a flooring material sample.

This sample was evaluated for adhesive tensile bond strength, wax adhesion, abrasion resistance, marring resistance, and conformability to a substrate by the following methods.

<Adhesive Tensile Bond Strength>

Adhesive tensile bond strength was examined according to the test method for measuring dry tensile bond strength as provided for in JIS A 5536 (Adhesives for vinyl flooring tiles/vinyl flooring sheets). The adhesives used were a vinyl copolymer resin adhesive for vinyl flooring materials (Nitto CementS2, manufactured by Nitto Boseki Co., Ltd.) and a urethane resin adhesive for vinyl flooring materials (Nitto Cement PU, manufactured by Nitto Boseki Co., Ltd.). In this test, the point to which attention should be directed besides tensile bond strength is the state of the fractured surfaces. When a fracture has occurred at AF (interface between the adhesive and the flooring material), this indicates that adhesion between the flooring material and the adhesive is low. It is desirable that a fracture occurs in F (flooring material itself) or at GA (interface between the substrate and the adhesive).

As a result, a sufficient tensile bond strength was obtained with each of the vinyl copolymer resin adhesive and urethane resin adhesive and there is no problem concerning the state of the fractured surfaces, as shown in Table 1 which will be given later.

<Wax Adhesion>

Wax adhesion was examined in the following manner. A wax for flooring materials (Status, manufactured by Johnson Company, Ltd.) was applied 3 times on the surface of a sample. An X-shaped incision was made in this wax layer. A pressure-sensitive adhesive tape (tape for corrugated-fiberboard packaging manufactured by Nichiban Co., Ltd.) was applied to the incised surface and sufficiently adhered to the wax layer. Thereafter, the pressure-sensitive adhesive tape was stripped off at a breath, and the wax layer on the sample surface was examined for peeling. The adhesion was evaluated in the following five grades..

5: The wax layer does not peel off at all.

4: The wax layer around the X-shaped incision partly peels off.

3: The wax layer around the X-shaped incision wholly peels off.

2: The wax layer other than that around the X-shaped incision also peels off partly.

1: The wax layer other than that around the X-shaped incision also peels off wholly.

Of these grades, the grades not lower than 4 indicate that the flooring material has sufficient performance.

As a resultt the sample was rated as 4 as shown in Table 1. The sample showed the sufficient performance required of flooring materials.

<Abrasion Resistance>

Abrasion resistance was examined according to the test method as provided for in JIS A 1453. The surface of a sample was abraded 3,000 times with a rubber ring having an abrasive paper wound therearound. The thickness loss caused by the abrasion was measured. Incidentally, since the abrasive paper is clogged due to abrasion, it was replaced by a fresh one at intervals of 500 times.

As a result, the thickness loss caused by abrasion was 0.83 mm as shown in Table 1.

<Marring Resistance>

For examining marring resistance, use is made of the testing machine as provided for in Federal Test Method Standard, Method 7711 “Scratch Resistance”. A test sample was bonded to the circular table of the testing machine without being subjected to any particular pretreatment. The table was rotated and a scratching blade on which a load of 500 g was imposed was dragged to form a scratch. The width and depth of this scratch were measured.

As a result, a scratch having a width of 2.0 mm and a depth of 0.10 mm was formed as shown in Table 1.

<Conformability to Substrate>

Conformability to a substrate was examined in the following manner. Plates having a width of 30 mm and thicknesses of 0.5 mm, 0.75 mm, and 1 mm were bonded toa flooring base (slate) to form a non-flat substrate. A urethane resin adhesive for vinyl flooring materials (Nitto Cement PU, manufactured by Nitto Boseki Co., Ltd.) was evenly applied to the substrate with a designated comb plate at ordinary temperature. After an open time of 30 minutes, a sample was applied thereto and pressed with a roller. After the adhesive had been completely cured, the sample was examined for conformability to the non-flat substrate. The conformability was evaluated in the following four grades.

4: The sample has conformed to all the flooring base protrusions and is in close contact with the flooring base.

3: The sample has conformed to the 0.5-mm and 0.75-mm flooring base protrusions but has not conformed to the 1-mm flooring base protrusion. The sample has lifted from the flooring base.

2: The sample has conformed to the 0.5-mm flooring base protrusion but has not conformed to the 0.75-mm and 1-mm flooring base protrusions. The sample has lifted from the flooring base.

1: The sample has not conformed to each flooring base protrusion and has lifted from the flooring base.

As a result, the sample was rated as 4 as shown in Table 1. The sample showed excellent conformability to the flooring base.

### EXAMPLES 2 TO 6

Thirty parts by mass of a copolymer of MMA and butyl acrylate (butyl acrylate content, 30% by mass; hereinafter referred to as “MMA-BA”) was further incorporated into the composition of Example 1. A flooring material sample of Example 2 was produced therefrom in the same manner as in Example 1.

Furthermore, 20 parts by mass of an ethylene/acrylic ester/maleic anhydride terpolymer (Bondine FX8000, manufactured by Sumitomo Chemical Co., Ltd.; hereinafter referred to as “modified polyethylene”) was further incorporated into the composition of Example 1. A flooring material sample of Example 3 was produced therefrom in the same manner as in Example 1.

Moreover, 20 parts by mass of a tackifier (Hi-rez 1515T, manufactured by Mitsui Chemicals, Inc.) was further incorporated into the composition of Example 1. A flooring material sample of Example 4 was produced therefrom in the same manner as in Example 1.

Furthermore, 30 parts by mass of the MMA-BA used in Example 2, 20 parts by mass of the modified polyethylene used in Example 3, and 20 parts by mass of the tackifier used in Example 4 were further incorporated into the composition of Example 1. A flooring material sample of Example 5 was produced therefrom in the same manner as in Example 1.

Furthermore, the same procedure as in Example 1 was conducted, except that 35 parts by mass of a hydrogenated styrene/butadiene block copolymer (MFR, 2.7 g/min; glass transition temperature, 14° C.; hereinafter referred to as “styrene/(poly)olefin copolymer 2”) was used in place of the styrene/(poly)olefin copolymer 1 in the composition of Example 1. Thus, a flooring material sample of Example 6 was produced.

These flooring material samples of Examples 2 to 6 were evaluated for adhesive tensile bond strength, wax adhesion, abrasion resistance, marring resistance, and conformability to a substrate in the same manners as in Example 1. The results thereof are also shown in Table 1 given below.

COMPARATIVE EXAMPLES 1 TO 3

Five parts by mass of the EVA1 used in Example 1 was compounded with 45 parts by mass of the low-density polyethylene used in Example 1, 50 parts by mass of the styrene/ (poly) olefin copolymer used in Example 1, and 500 parts by mass of the calcium carbonate used in Example 1. A flooring material sample of Comparative Example 1 was produced therefrom in the same manner as in Example 1.

Furthermore, 100 parts by mass of an ethylene/vinyl acetate copolymer having a vinyl acetate content of 40% by mass (Evaflex EV40L, manufactured by Mitsui Chemicals, Inc.; hereinafter referred to as EVA2) was compounded with 500 parts by mass of the calcium carbonate used in Example 1. A flooring material sample of Comparative Example 2 was produced therefrom in the same manner as in Example 1.

Moreover, 40 parts by mass of the EVA1 used in Example 1 was compounded with 60 parts by mass of the low-density polyethylene used in Example 1 and 500 parts by mass of the calcium carbonate used in Example 1. A flooring material sample of Comparative Example 3 was produced therefrom in the same manner as in Example 1.

The flooring material samples of Comparative Examples 1 to 3 also were evaluated for adhesive tensile bond strength, wax adhesion, abrasion resistance, marring resistance, and conformability to a substrate in the same manners as in Example 1. The results thereof are also shown in Table 1 given below.

TABLE 1

| | | | | | | | | Comparative | | |
|---|---|---|---|---|---|---|---|---|---|---|
| | | Example | | | | | | Example | | |
| | | 1 | 2 | 3 | 4 | 5 | 6 | 1 | 2 | 3 |
| Ingredients | | | | | | | | | | |
| (parts by mass) | | | | | | | | | | |
| EVA1 | | 30 | 30 | 30 | 30 | 30 | 30 | 5 | | 40 |
| EVA2 | | | | | | | | | 100 | |
| Polyethylene | | 35 | 35 | 35 | 35 | 35 | 35 | 45 | | 60 |
| Styrene/(poly) olefin | | 35 | 35 | 35 | 35 | 35 | | 50 | | |
| copolymer 1 | | | | | | | | | | |
| Styrene/(poly) olefin | | | | | | | 35 | | | |
| copolymer 2 | | | | | | | | | | |
| MMA-BA | | | 30 | | | 30 | | | | |
| Calcium carbonate | | 500 | 500 | 500 | 500 | 500 | 500 | 500 | 500 | 500 |
| Modified polyethylene | | | | 20 | | 20 | | | | |
| Tackifier | | | | | 10 | 10 | | | | |
| Evaluation of Properties | | | | | | | | | | |
| Adhesive | Vinyl | 0.78 | 0.80 | 0.76 | 0.82 | 0.81 | 0.81 | 0.40 | 0.45 | 0.71 |
| peel | copolymer | | | | | | | | | |
| strength | State of | GA | GA | GA | GA | GA | GA | AF | AF | GA |
| (N/mm²) | peeled | | | | | | | | | |
| | surface | | | | | | | | | |
| | Urethane | 1.09 | 1.11 | 1.00 | 1.16 | 1.13 | 0.97 | 0.55 | 0.72 | 1.08 |
| | resin | | | | | | | | | |
| | State of | GA | GA | GA | GA | GA | GA | AF | AF | GA |
| | peeled | | | | | | | | | |
| | surface | | | | | | | | | |
| Wax adhesion (1-5) | | 4 | 4 | 4 | 5 | 5 | 4 | 2 | 2 | 4 |
| Abrasion resistance (mm) | | 0.83 | 0.80 | 0.75 | 0.83 | 0.72 | 0.82 | 0.82 | 0.98 | 0.92 |
| Marring | Width (mm) | 2.0 | 1.7 | 2.0 | 2.0 | 1.7 | 1.9 | 1.9 | 3.2 | 2.9 |
| resistance | Depth (mm) | 0.10 | 0.07 | 0.11 | 0.10 | 0.08 | 0.11 | 0.09 | 0.21 | 0.19 |

| | | | | | | | | | |
|---|---|---|---|---|---|---|---|---|---|
| Conformability to | 4 | 4 | 4 | 4 | 4 | 4 | 4 | 1 | 2 |
| substrate (1-4) | | | | | | | | | |

Table 1 is discussed first fromt the standpoint of tensile bond strength. The samples of Examples 1 to 5, in which EVA1 was used, the sample of Example 6, in which styrene/ (poly)olefin copolymer 2 was used, and the sample of Comparative Example 3 had a sufficient tensile bond strength with respect to each of the vinyl copolymer resin adhesive and the urethane resin adhesive, and were satisfactory in the state of the fractured surfaces. In particular, the samples of Examples 4 and 5, in which a tackifier had been incorporated, had a further enhanced tensile bond strength. However, the sample of Comparative Example 1, in which the amount of EVA1 incorporated was smaller than 10 parts by mass, and the sample of Comparative Example 2, which did not contain EVA1, did not have a sufficient tensile bond strength even with EVA2, which had a relatively high vinyl acetate content. It can be seen also from the state of the fractured surfaces that sufficient adhesion was not obtained between each of these two flooring materials and the adhesives.

The same as in the tensile bond strength applies to wax adhesion.

With respect to abrasion resistance, a comparison between Example 1 and Comparative Example 3 shows that the addition of the styrene/polyolefin copolymer remarkably improved abrasion resistance. Furthermore, a comparison between Examples 1 and 3 and a comparison between Examples 4 and 5 show that the addition of the modified polyethylene further improved abrasion resistance.

With respect to marring resistance, it can be seen that the addition of a styrene/polyolefin copolymer resulted in a reduction in scratch width and depth and remarkably improved marring resistance. Furthermore, a comparison between Examples 1 and 2 and a comparison between Examples 4 and 5 show that the addition of MMA-BA further improved marring resistance.

With respect to conformability to a substrate, a comparison between the Examples and the Comparative Examples shows that the addition of a styrene/polyolefin copolymer remarkably improved conformability to the substrate.

As apparent from the explanations given above, the flooring material of the invention not only tenaciously adheres to existing adhesives and waxes for flooring materials but also has remarkably improved conformability to substrates. Because of this, a highly satisfactory finish is obtained after application thereof. The flooring material is excellent also in durability, such as abrasion resistance and marring resistance. The flooring material of the invention can hence be regarded as a highly excellent flooring material.

Furthermore, flooring materials were produced in the same manners as in Examples 1 to 5, except that the polystyrene/1,2-polyisoprene block copolymer was replaced by the same amount of a hydrogenated polystyrene/polybutadiene block copolymer (MFR, 2.7 g/10 min; glass transition temperature, 14° C.; hereinafter referred to as “styrene/(poly)olefin copolymer 2”). As a result, the same results were obtained.

### EXAMPLE 7

Thirty parts by mass of an ethylene/vinyl acetate copolymer having a vinyl acetate content of 70% by mass (same as the “EVA1” used in Example 1) was evenly compounded with 35 parts by mass of an ethylene/methyl methacrylate copolymer (Acryft CM8014, manufactured by Sumitomo Chemical Co., Ltd.; MFR, 4 g/10 min; hereinafter referred to as “polyolefin”), 35 parts by mass of a polystyrene/vinylpolyisoprene block copolymer (same as the “styrene/(poly)olefin copolymer 1” used in Example 1), and 200 parts by mass of a calcium carbonate powder having an average particle diameter of 100 μm. A die having a given orifice shape was attached to an extruder, and the composition obtained above was molded into a sheet having a thickness of 2 mm. A skirting board sample was thus produced.

This sample was evaluated for adhesive tensile bond strength, unsusceptibility to blushing in bending, and conformability to a substrate by the following methods.

<Adhesive Tensile Bond Strength>

Adhesive tensile bond strength was examined according to the test method for measuring dry 90-degree peel bond strength as provided for in JIS A 5536 (Adhesives for vinyl flooring tiles/vinyl flooring sheets). The adhesive used was an emulsion type adhesive for vinyl skirting boards (EM Habaki, manufactured by Tilement).

As a result, a sufficient peel bond strength was obtained as shown in Table 2 which will be given later.

<Unsusceptibility to Blushing in Bending>

Unsusceptibility to blushing in bending was examined by the following test method. A skirting board sample was aged for 48 hours in an atmosphere having a temperature of 20° C. and a humidity of 65%. Thereafter, in the same atmosphere, the skirting board sample was wound over an angle of 180° around rods which had completely circular cross-sections and variously differed in diameter. The diameter of the rod on which the skirting board sample blushes is used as an index to the unsusceptibility of the skirting board sample to blushing in bending. For example, when a skirting board sample blushes upon winding over an angle of 180° around a rod having a diameter of 10 mm, then the unsusceptibility of this skirting board sample to blushing in bending is taken as 10R. In this test, it is a matter of course that the smaller the value, the better the unsusceptibility to blushing in bending.

As a result, sufficient unsusceptibility to blushing in bending was obtained as shown in Table 2.

<Conformability to Substrate>

Conformability to a substrate was examined in the following manner. Plates having a width of 30 mm and thicknesses of 1 mm, 1.5 mm, and 2 mm were bonded to a substrate (slate) to form a non-flat substrate. An emulsion type adhesive for vinyl skirting boards (EM Habaki, manufactured by Tilement) was evenly applied to the substrate with a designated comb plate at ordinary temperature. After an open time of 20 minutes, a sample was applied thereto and pressed with a roller. After the adhesive had been completely cured, the sample was examined for conformability to the non-flat substrate. The conformability was evaluated in the following four grades.

4: The sample has conformed to all the substrate protrusions and is in close contact with the substrate.

3: The sample has conformed to the 1-mm and 1.5-mm substrate protrusions but has not conformed to the 2-mm substrate protrusion. The sample has lifted from the substrate.

2: The sample has conformed to the 1-mm substrate protrusion but has not conformed to the 1.5-mm and 2-mm substrate protrusions. The sample has lifted from the substrate.

1: The sample has not conformed to each substrate protrusion and has lifted from the substrate.

As a result, the sample was rated as 4 as shown in Table 2. The sample showed excellent conformability to the substrate.

### EXAMPLES 8 TO 12

Ten parts by mass of the modified polyethylene used in Example 3 was further incorporated into the composition of Example 7. A skirting board sample of Example 8 was produced therefrom in the same manner as in Example 7.

Furthermore, 10 parts by mass of the tackifier used in Example 4 was further incorporated into the composition of Example 7. A skirting board sample of Example 9 was produced therefrom in the same manner as in Example 7.

Moreover, an ionomer resin (Himilan 1652, manufactured by Mitsui Chemicals, Inc.; MFR, 5 g/10 min; hereinafter referred to as “ionomer”) was superposed-in a thickness of 100 μm as a surface layer on the skirting board of Example 7 by coextrusion to thereby produce a flooring material sample of Example 10. A nylon resin was likewise superposed in a thickness of 100 pm to produce a skirting board sample of Example 11.

Furthermore, the same procedure as in Example 7 was conducted, except that 35 parts by mass of a hydrogenated styrene/butadiene block copolymer (MFR, 2.7 g/min; glass transition temperature, 14° C.; “styrene/(poly)olefin copolymer 2”) was used in place of the styrene/(poly)olefin copolymer 1. Thus, a skirting board sample of Example 12 was produced.

These skirting board samples of Examples 8 to 12 were evaluated for dry 90-degree adhesive peel bond strength, unsusceptibility to blushing in bending, and conformability to a substrate in the same manners as in Example 7. The results thereof are also shown in Table 2.

### COMPARATIVE EXAMPLES 4 TO 6

Five parts by mass of the EVA1 used in Example 6 was compounded with 45 parts by mass of the polyolefin used in Example 7, 50 parts by mass of the styrene/(poly)olefin copolymer used in Example 6, and 200 parts by mass of the calcium carbonate used in Example 7. A skirting board sample of Comparative Example 4 was produced therefrom in the same manner as in Example 7.

A hundred parts by mass of the EVA2 used in Comparative Example 2 was compounded with 200 parts by mass of the calcium carbonate used in Example 7, and a skirting board sample of Comparative Example 5 was produced therefrom in the same manner as in Example 7. Furthermore, 40 parts by mass of the EVAl used in Example 7 was compounded with 60 parts by mass of the polyolefin used in Example 6 and 200 parts by mass of the calcium carbonate used in Example 7, and a skirting board sample of Comparative Example 6 was produced therefrom in the same manner as in Example 7.

The skirting board samples of Comparative Examples 4 to 6 also were evaluated for dry 90-degree adhesive peel bond strength, unsusceptibility to blushing in bending, and conformability to a substrate in the same manners as in Example 7 . The results thereof are also shown in Table 2.

TABLE 2

| | | | | | | | Comparative | | |
|---|---|---|---|---|---|---|---|---|---|
| | Example | | | | | | Example | | |
| | 7 | 8 | 9 | 10 | 11 | 12 | 4 | 5 | 6 |
| Ingredients | | | | | | | | | |
| (parts by mass) | | | | | | | | | |
| EVA1 | 30 | 30 | 30 | 30 | 30 | 30 | 5 | | 40 |
| EVA2 | | | | | | | | 100 | |
| Polyolefin | 35 | 35 | 35 | 35 | 35 | 35 | 45 | | 60 |
| Styrene/(poly) - | 35 | 35 | 35 | 35 | 35 | | 50 | | |
| olefin copolymer 1 | | | | | | | | | |
| Styrene/(poly) - | | | | | | 35 | | | |
| olefin copolymer 2 | | | | | | | | | |
| Calcium carbonate | 200 | 200 | 200 | 200 | 200 | 200 | 200 | 200 | 200 |
| Modified | | 10 | | | | | | | |
| polyethylene | | | | | | | | | |
| Tackifier | | | 10 | | | | | | |
| Surface layer, | | | | present | | | | | |
| ionomer resin | | | | | | | | | |
| Surface layer, | | | | | present | | | | |
| nylon resin | | | | | | | | | |
| Evaluation of | | | | | | | | | |
| Properties | | | | | | | | | |
| Adhesive peel | 18.0 | 18.5 | 20.0 | 18.0 | 18.5 | 18.5 | 9.0 | 10.0 | 17.0 |
| strength | | | | | | | | | |
| (N/25 mm) | | | | | | | | | |
| Unsusceptibility | 3R | 2R | 3R | not | not | 3R | 3R | 13R | 6R |
| to blushing in | | | | blushed | blushed | | | | |
| bending | | | | | | | | | |
| Conformability | 4 | 4 | 4 | 4 | 4 | 4 | 4 | 1 | 2 |
| to substrate (1-4) | | | | | | | | | |

Table 2 is discussed first from the standpoint of tensile bond strength. The samples of Examples 7 to 11, in which EVA1 was used, the sample of Example 12, in which styrene/(poly)olefin copolymer 2 was used, and the sample of Comparative Example 6 had a sufficient tensile bond strength. In particular, the sample of Example 9, in which a tackifier had been incorporated, had a further enhanced tensile bond strength. However, the sample of Comparative Example 4, in which the amount of EVA1 incorporated was smaller than 10 parts by mass, and the sample of Comparative Example 5, which did not contain EVA1, did not have a sufficient tensile bond strength. even with EVA2, which had a relatively high vinyl acetate content. It can be seen that sufficient adhesion was not obtained between each of these two skirting boards and the adhesive.

With respect to unsusceptibility to blushing in bending, it can be seen that the addition of a styrene/polyolefin copolymer remarkably improved the unsusceptibility to blushing. The addition of the modified polyethylene further improved it. The superposition of an ionomer resin or nylon resin as a surface layer improves the property to such a degree that the sample does not blush even when bent at an angle of 180° without being wound around a rod.

With respect to conformability to a substrate, a comparison between the Examples and the Comparative Examples shows that the addition of a styrene/polyolefin copolymer remarkably improved conformability to the substrate.

As apparent from the explanations given above, the resinous skirting board of the invention can be tenaciously bonded with existing adhesives for skirting boards and is satisfactory also in unsusceptibility to blushing in bending and conformability to substrates. The skirting board hence has highly excellent applicability. In addition, the skirting board having a surface layer formed by superposing an ionomer resin or nylon resin has high marring resistance and is a skirting board with excellent durability.

Furthermore, skirting boards were produced in the same manners as in Examples 7 to 12, except that the polystyrene/1,2-polyisoprene block copolymer was replaced by the same amount of a hydrogenated polystyrene/polybutadiene block copolymer (MFR, 2.7 g/10 min; glass transition temperature, 14° C.; styrene/(poly)olefin copolymer 2). As a result, the same results were obtained.

Industrial Applicability

The resinous interior material of the invention contains neither halogens nor plasticizers such as phthalic esters, can be used as a substitute for PVC-based interior materials heretofore in use, and has excellent adhesion to existing adhesives and waxes for interior materials. In addition, the resinous interior material is markedly superior to other interior materials made of non-halogen resins in processability, applicability, and durability. It is exceedingly useful especially as a flooring material or a skirting board.

1. A resinous interior material comprising 10 to 45 parts by mass of an ethylene/vinyl acetate copolymer, 10 to 90 parts by mass of a polyolefin resin, 10 to 90 parts by mass of either a block copolymer of styrene and one or more aliphatic unsaturated hydrocarbon compounds or a product of hydrogenation of the copolymer (hereinafter referred to as styrene/(poly)olefin block copolymer), and 100 to 700 parts by mass of an inorganic filler.

2. The resinous interior material as claimed in claim 1, wherein the ethylene/vinyl acetate copolymer has a vinyl acetate concentration of 50% or higher and the ethylene/vinyl acetate copolymer has a melt flow rate (hereinafter referred to as MFR) which is higher by at least 20 g/10 min than MFR's of other resins.

3. The resinous interior material as claimed in claim 1, wherein the styrene/(poly)olefin block copolymer has a glass transition temperature (T_{g} or tan δ absorption) of from −20° C. to +50° C.

4. The resinous interior material as claimed in claim 1, wherein the aliphatic unsaturated hydrocarbon compounds in the styrene/(poly)olefin block copolymer comprise an aliphatic unsaturated hydrocarbon compound having 3 or more carbon atoms.

5. A flooring material produced by compounding 10 to 50 parts by mass of an ethylene/vinyl acetate copolymer having a vinyl acetate concentration of 50% or higher and an MFR of 40 to 100 g/10 min with 10 to 90 parts by mass of a polyolefin resin having an MFR of 1 to 20 g/10 min, 10 to 90 parts by mass of a styrene/(poly)olefin block copolymer having a glass transition temperature around ordinary temperature and an MFR of 1 to 20 g/10 min, and 400 to 700 parts by mass of an inorganic filler and molding the resultant composition into a single-layer structure.

6. The flooring material as claimed in claim 5, wherein a copolymer of methyl methacrylate and an acrylic ester is fuirther compounded in an amount of 10 to 50 parts by mass.

7. The flooring material as claimed in claim 5, wherein an ethylene/acrylic ester/maleic anhydride terpolymer is further compounded in an amount of 10 to 30 parts by mass.

8. The flooring material as claimed in claim 5, wherein a tackifier is further compounded in an amount of 1 to 30 parts by mass.

9. The flooring material as claimed in claim 5, which is a flooring tile.

10. A skirting board produced through compounding 10 to 45 parts by mass of an ethylene/vinyl acetate copolymer having a vinyl acetate concentration of 50% or higher and an MFR of 40 to 100 g/10 min with 10 to 90 parts by mass of a polyolefin resin having an MFR of 1 to 20 g/10 min, 10 to 90 parts by mass of a styrene/(poly)olefin block copolymer having a glass transition temperature around ordinary temperature and an MFR of 1-20 g/10 min, and 150 to 400 parts by mass of an inorganic filler.

11. The skirting board as claimed in claim 10, wherein an ethylene/maleic anhydride copolymer or an ethylene/methacrylic acid copolymer is further compounded in an amount of 1 to 30 parts by mass.

12. The skirting board as claimed in claim 10, wherein a tackifier is further compounded in an amount of 1 to 30 parts by mass.

13. The skirting board as claimed in claim 10, which has a surface layer formed by superposing an ionomer resin.

14. The skirting board as claimed in claim 10, which has a surface layer formed by superposing a nylon resin.
